(19) United States
(12) Patent Application Publication
(10) Pub. No.: US 2010/0142201 A1
(43) Pub. Date: Jun. 10, 2010

(54) LIGHTING APPARATUS

(75) Inventor: Franco Venturini, Milano (IT)

Correspondence Address: Pearne & Gordon LLP, 1801 East 9th Street, Suite 1200, Cleveland, OH, 44114-3108, US

(73) Assignee: WISSENLUX S.R.L., 20123 MILANO (IT)

(21) Appl. No.: 12/525,246

(22) PCT Filed: Jan. 29, 2008
(86) PCT No.: PCT/EP08/00669

§ 371 Date: Feb. 19, 2010

(30) Foreign Application Priority Data
Feb. 7, 2007 (IT) MI2007A000224
Apr. 23, 2007 (EP) 07106727.6

(51) Int. Cl. F21V 1/00; F21S 4/00

(52) U.S. Cl. 362/235; 362/249.02; 362/249.03

(57) ABSTRACT

Lighting apparatus provided with a light source (60) formed by means of a plurality of LED-type light emitters (21) able to generate single light beams (R) which arc optically directed by means of lenses (24) mounted on a shaped base in respective planes of lie (P) so as to produce an overall beam of light with an orientation defined by the direction (R) of said individual beams and by the lie of the emitters (21).

### TECHNICAL FIELD

The present invention relates to a lighting apparatus of the LED (Light Emitting Diode) type, in particular for use in street lamps, external lamps, floodlights, spotlights and internal lighting, and the description which follows will be provided with reference to this field of application solely for the sake of simplification of the explanations given.

As is well known, conventional lighting apparatus such as street lamps usually have a support structure, normally a post and an end part (called “whip arm”) on which a lighting unit which contains the light emitting apparatus is mounted.

Conventionally, these apparatus are contained in a support structure having a substantially flat and uniform surface which houses sources for emitting the light which is always irradiated perpendicularly with respect to the surface.

The light emitted from a conventional lamp, however, is also diffused in directions different from that of the beam emitted by the source, being dispersed also in directions above a hypothetical line known as “horizon line”, this being defined as a circular line which separates the earth from the sky with the observer at the centre thereof.

Such dispersion is usually considered to be the main source of so-called “light pollution”.

“Light pollution” may be defined as being, more generally, any form of artificial light radiation outside of the areas within its intended working range and, in particular, directed towards the sky. It has numerous negative effects both on human lifestyle and on the surrounding environment.

Such a form of irradiation is the cause of considerable wasted energy (in blatant breach of the recommendations of the Kyoto Protocol) with a negative impact on public administration costs and also implications of a social and cultural nature, such as the reduced visibility of the sky and the stars and the poor illumination of monuments, as well as consequences in the scientific sphere, such as the increasing difficulty of observing and studying the behaviour of celestial bodies without the use of sophisticated equipment which is not influenced by the light pollution from the earth.

In 1992, UNESCO issued the Declaration on the Rights of Future Generations in which the right to conserve a completely pure state of the sky was established.

In the same year, at the convention “Rencontres du Ciel et de l'Espace” held in Paris, the Italian Astrophile Union proposed addressing an appeal to the Council of Europe in order to obtain a vote committing the European Commission to issue a specific directive limiting light pollution; this was intended to embrace all the various types of external lighting systems, including those used for advertising and for illumination of monuments, with particular reference also to the use of systems for reducing power consumption.

In 1998 light pollution was included by the European Community in a document planning discussion and action on a territorial and environmental level. As a result, during the following years, measures for limiting light pollution were adopted in Europe; seven Italian regions even promoted and approved regional laws relating to protection of the night-time sky and energy saving.

In particular the Region of Lombardy, with Law No. 17/2000 and subsequent amendments, regulated the light emission for external lighting systems with the aim of reducing light pollution and banned any form of external illumination which was directed above the horizon line.

Following the issue of this law, for example, street lamps according to the known art with a whip arm, along with many other types of floodlights, spotlights, etc., were not considered to comply with the regulations.

The object of the present invention is to provide a lighting apparatus which is improved in terms of reduced dispersion of the light emitted and energy saving.

Another object is to provide an improved lighting apparatus in compliance with the existing legislation on light pollution.

A further object is to provide an improved lighting apparatus in terms of size and weight.

Moreover, the high thermal dispersion of non-polarised light is the cause of the high internal temperature of the lighting unit (which may also reach a few hundreds of degrees) and the consequent reduction in its working life.

An important object is therefore also to provide a lighting apparatus which is improved in terms of operating temperature.

### DISCLOSURE OF THE INVENTION

The technical problem is solved by a lighting apparatus comprising a shaped base for emitting light generated by at least one and preferably a plurality of light beam emitters (LEDs), characterized in that said shaped base is inclined in at least one portion thereof at a predetermined angle with respect to the vertical.

The characteristic features and advantages of the invention will emerge from the description provided hereinbelow of an example of embodiment thereof provided by way of non-limiting example with reference to the accompanying drawings.

### BRIEF DESCRIPTION OF THE DRAWINGS

FIG. 1a shows a schematic overall view of a lighting system provided with a first example of a lighting apparatus according to the invention, with some parts cross-sectioned so that other parts may be seen more clearly;

FIG. 1b shows in detail the lighting apparatus according to FIG. 1a;

FIG. 2a shows a schematic bottom plan view of the lighting apparatus according to the invention;

FIG. 2b shows a schematic bottom plan view of a variant of the lighting apparatus according to the invention;

FIG. 3a shows a perspective view, from the bottom upwards, of the lighting apparatus according to the invention with some parts removed so that other parts may be seen more clearly;

FIG. 3b shows a detail of FIG. 3a;

FIG. 4a shows an overall view of a lighting system provided with a second example of a lighting apparatus according to the invention, with some parts cross-sectioned so that other parts may be seen more clearly;

FIG. 4b shows a longitudinally sectioned view of the lighting apparatus according to FIG. 4a;

FIG. 5a shows a perspective view of a further preferred example of embodiment of the lighting apparatus according to the invention;

FIG. 5b shows a schematic view of a section of the lighting apparatus according to FIG. 5a.

### DETAILED DESCRIPTION

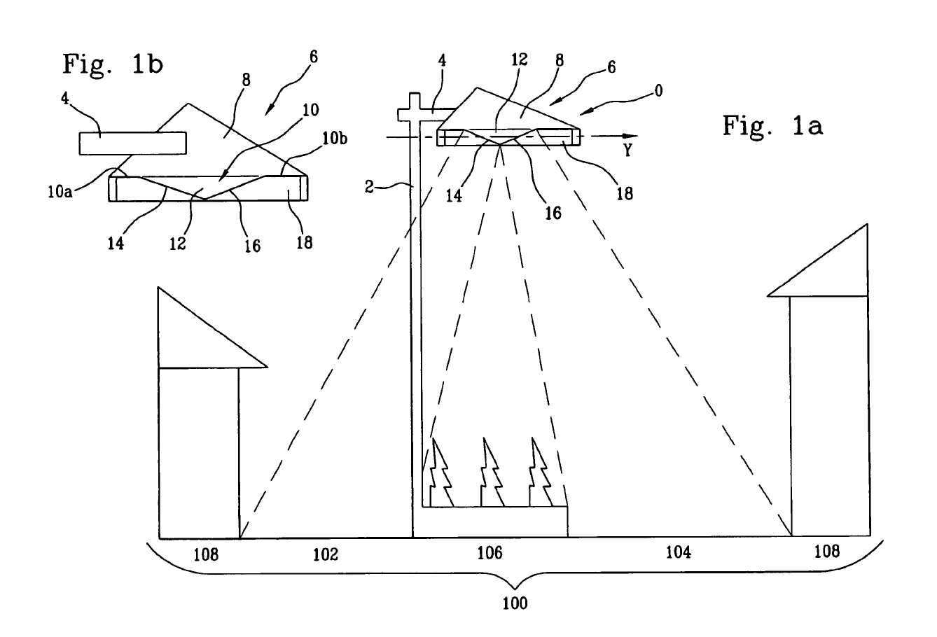

With reference to these figures, FIG. 1a shows in schematic form a street lamp, in compliance with law No. 17/2000 and subsequent amendments issued by the region of Lombardy, comprising a post 2 with an extended arm 4 having, fastened thereto, a lighting apparatus 6 according to the invention comprising a support structure 8 for housing cables conveying the electric power to a light source 60 which is mechanically associated with the support structure 8 on a bottom side 8′ thereof.

In greater detail, according' to the invention, the lighting apparatus 6 envisages that the light source is formed by a plurality of LED-type light emitters 21, each of which is able to generate a single beam of light which is optically directed with rays indicated by way of example by the lines R.

According to the invention, moreover, the support structure 8 comprises a shaped base 10 on which a plurality of emitters 21 is mounted, said emitters lying in respective planes of lie P defined by the shaped base 10 and able to form at least one overall beam of light with an orientation defined by the direction of the individual beams R and by the lie P of the emitters 21.

Preferably, the individual beams R are perpendicular to the lie P of the respective emitter 21.

The optimum light beam in accordance with the objects of the invention is therefore obtained by means of the possibility of orienting the light beams produced by the LEDs in the manner described above.

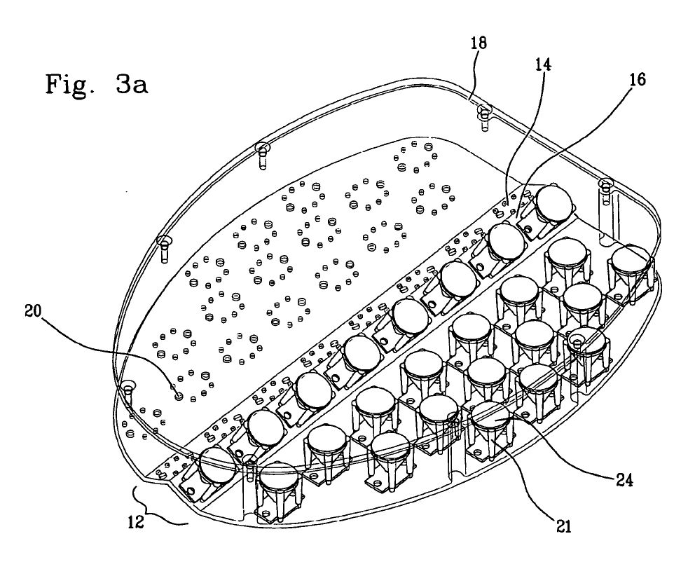

Furthermore, the rays R emitted by the LEDs pass through lenses 24 which are arranged above the emitters 21, as illustrated in FIG. 3b.

The lenses 24 allow the rays of light emitted by the LEDs to be focussed, keeping them within a predetermined angle of emission and avoiding unnecessary dispersion.

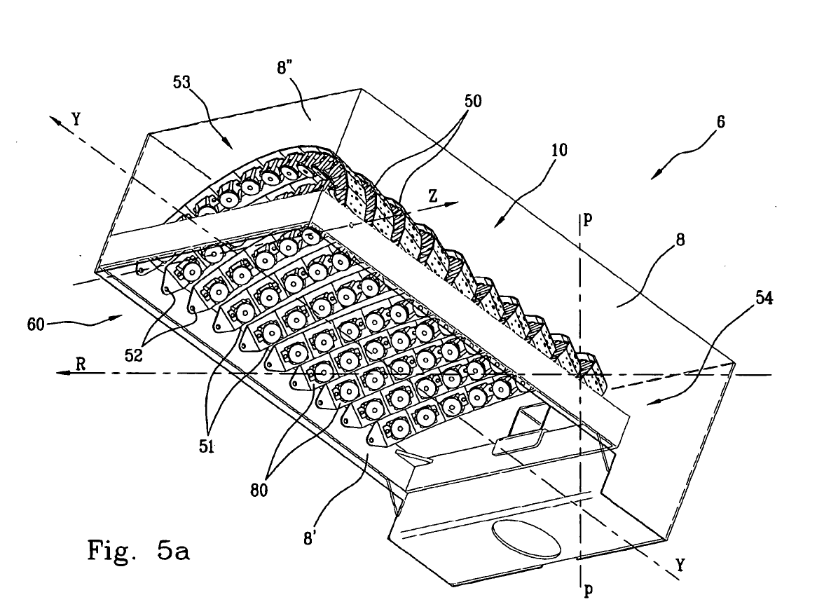

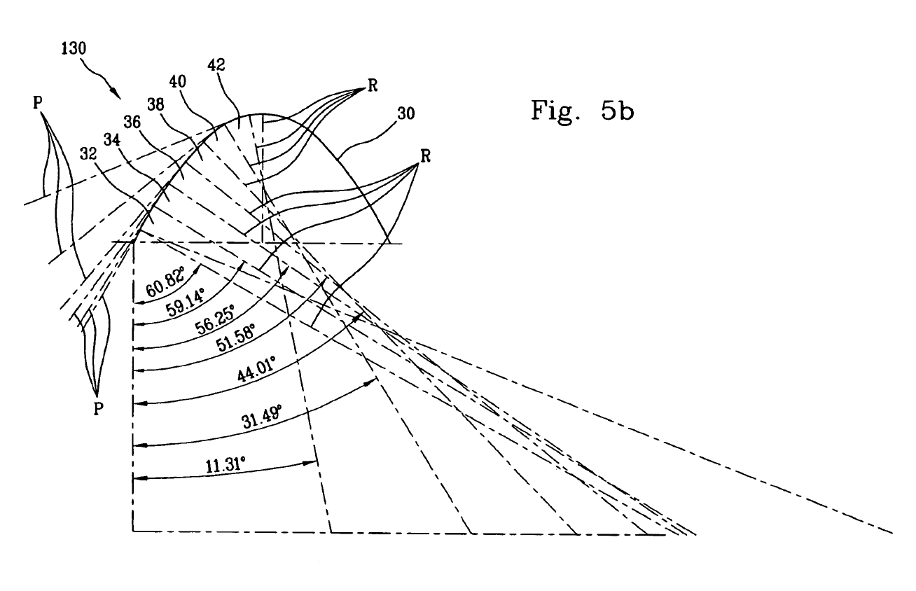

In accordance with a preferred embodiment of the present invention shown in FIG. 5a, the shaped base 10 is formed by means of two or more curved profiles 50 which are arranged substantially alongside each other so as to form a series in a longitudinally extending direction Y.

Each profile 50 is connected at its ends 51 by means of hinges 52 to the support structure 8 and can be oriented by means of rotation about the common axis of rotation Z of the abovementioned hinges 52 (the figure shows the axis of the second profile 50).

The position of the curved profiles 50 may be advantageously maintained by means of the frictional force during rotation.

It is possible to define for the apparatus 6 a normal operative position O (see FIGS. 1a, 4a, 5b) intended to direct the light downwards and therefore with the bottom side 8′ of the support structure 8 substantially facing the ground.

In this condition the concavity of the curved profiles 50 is directed downwards and their direction of longitudinal extension Y is horizontal and parallel to the ground, while the hinges 102 are aligned on the axis of rotation Z, which is in particular horizontal and perpendicular to the direction Y.

By using a series of curved profiles 50 which can be oriented by means of rotation about the axis Z, it is possible to obtain further adjustment of the light beam produced by the apparatus 6.

Preferably for example, as can be easily understood from FIG. 5a, the curved profiles 50 situated in the vicinity of a first end 53 of the series (for example the first 1-5 profiles) may define beams oriented with a component towards the second end 54 of the series (in the case of the configuration according to FIG. 5a it is necessary to envisage rotating further the top of the curved profiles 50 a few degrees towards the end closing side 8″), while the curved profiles situated in the vicinity of the second end 54 of the series may define beams oriented with a component towards the first end 53 of the series, producing an intersection of the light rays.

Differently, the shaped base 10 may be formed as a single body without there being therefore the abovementioned possibility of adjustment.

The shaped base 10 defines a downwardly directed concavity which houses inside it the light sources and which is formed as an extension in the longitudinal direction Y of a downwardly concave line indicated in FIG. 5b. Furthermore the shaped base 10 may be formed both as a single body and in the form of curved profiles arranged alongside each other by means of flat supports 80 which are connected together mechanically at the periphery and each support an emitter 21.

In this case the concave line of extension will consist of the series of segments of a polygonal element.

Preferably, the adjustments mentioned above will be performed by keeping the shaped base 10 with a respective lie of the emitters so that the rays are inclined relative to a horizontal plane at an angle of no more than 12 degrees, thus keeping the light rays emitted within the horizon line.

As shown in FIG. 5b, the shaped base 10 has a form, the cross-section of which is defined by a concave line 30 relative to a sectional plane perpendicular to the longitudinal extension Y; in this figure, the concave line 30 has a polygonal form and consists for example of polygon segments 32, 34, 36, 38, 40, 42, etc.

With such a shaped base, the light beams are concentrated towards a common predetermined object, ensuring lighting thereof which is superior to conventional lighting, while respecting the criteria of energy saving and low light pollution.

According to the invention, the shaped base 10 is inclined, in at least one portion thereof, at a predetermined angle with respect to the vertical.

According to a different embodiment of the invention, the shaped base 10 has a form, the cross-section of which is defined by an upwardly concave line which is provided with a rib 12 having two shoulders 14 and 16 which are inclined relative to the vertical and enclosed by a cover 18 fixed to the support structure 8.

According to the invention, the rib 12 may be made both of ferrous material and of other material with different properties; preferably the surface of this rib is non-reflective owing to the fact that the beams of light emitted by the LEDs according to the invention are directed in a suitable direction using the focussing lenses 24.

FIG. 1b shows in greater detail and on a larger scale the LED lighting apparatus 6 according to the invention.

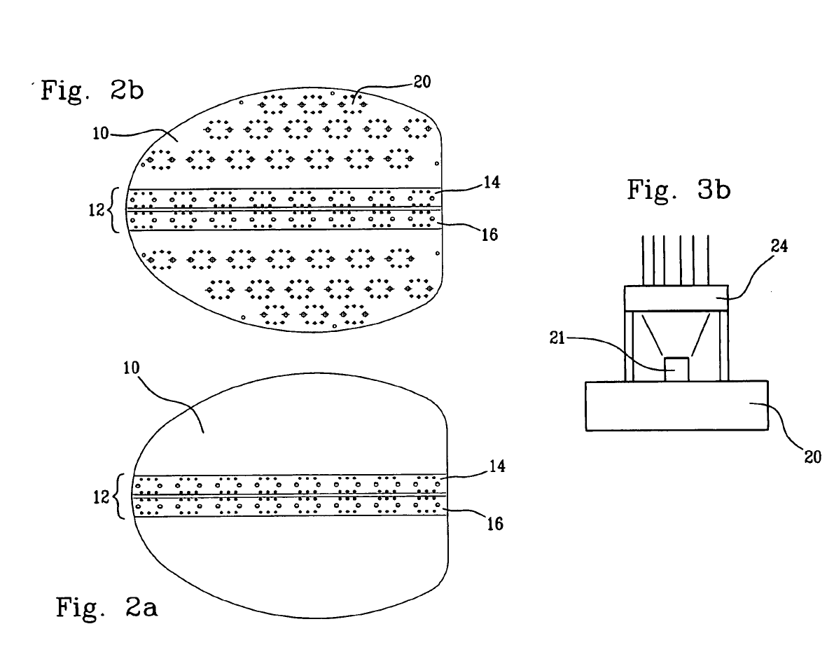

The shaped base 10, and in particular the two shoulders 14, 16, are provided with seats 20 for light beam emitters 21, in particular class A2 laser ray emitters, as shown in FIGS. 2, 2b and 3; the emission of rays is performed by means of LEDs, following which the rays pass through the lenses 24 arranged above the emitters 21, as shown in FIG. 3b.

In FIG. 2, the seats 20, in a first variant, are provided only on the shoulders of the rib 12, while in FIG. 2b the emitters 20, in a second variant, are also provided on the flat portion of the shaped base 10.

According to the invention, the light beam emitters (LEDs) 21 are distributed over the shaped base 10, and in particular on the rib 12, so that the light beams generated are oriented only towards the required targets, with the light not being dispersed in other directions, thus avoiding the unnecessary wastage of energy.

The light is oriented, with respect to the vertical, at an angle equal to the angle of inclination of the shoulders 14, 16 relative to the said vertical. The angle of inclination is such as to prevent the light rays emitted by the LEDs from being dispersed beyond the horizon line.

FIG. 1a shows an example where a road 100, which has two lanes 102 and 104 and is separated by a flowerbed with hedge 106 and bordered by houses 108, requires illumination only of the lanes for passing cars 102, 104 and a small portion of the flowerbed with hedge 106.

Owing to the arrangement of the light beam emitters 21 on the shoulders 14 and 16 of the rib 12, which has been specially prepared, the light beams are oriented exactly so as to illuminate the required targets, minimizing the dispersion of light, energy consumption and, consequently, minimizing the light pollution associated with the lighting system.

The orientation of the beams from the shoulders 14, 16 may be symmetrical or asymmetrical with respect to a middle plane vertical and transverse to the longitudinal extension Y of the apparatus, depending on the working requirements.

In particular, depending on the morphology of the zones to be illuminated, ribs with different sizes and inclinations may be formed.

In accordance with the examples according to FIGS. 1 to 4, the lighting apparatus 6, which is sectioned longitudinally, has the appearance of an upwardly concave broken polygonal line; in the case of FIG. 1a, the polygonal line is formed by four segments, a first segment 10a, a second and third segment identified by the first shoulder 14 and second shoulder 16 of the rib 12 and a fourth segment 10b.

The polygonal line of each individual rib is a triangle having the base perpendicular to the vertical or a right-angled triangle having a cathetus perpendicular to the vertical.

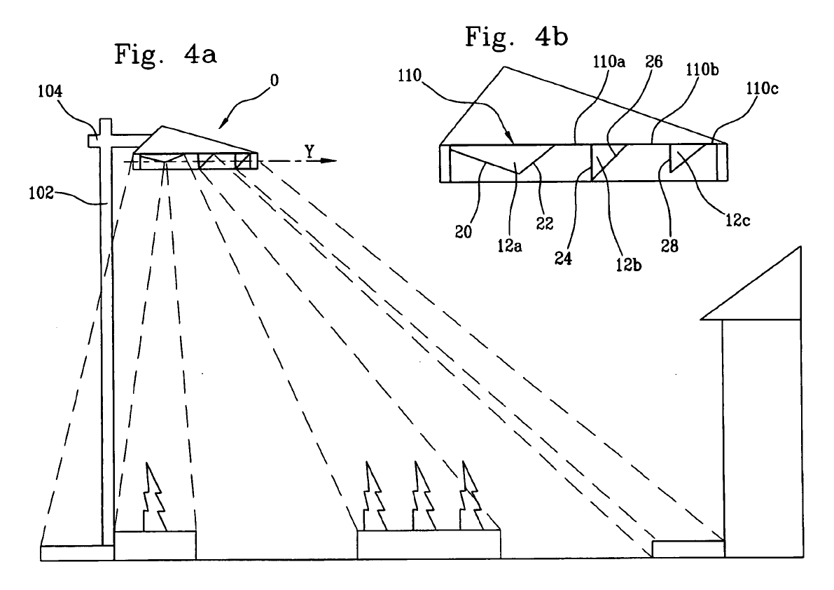

According to a further embodiment of the invention, a shaped base 110 is provided with a plurality of ribs; with reference, for example, to FIGS. 4a and 4b, it is possible to see four ribs 12a, 12b and 12c with respective shoulders 20 and 22, 24 and 26, 28 and 30.

The parts present in FIGS. 4a and 4b, already present in FIGS. 1a and 1b, have identification numbers increase by 100.

According to the invention, the light beam emitters (LEDs) 21 emit light of varying intensities depending on the target of the light emitted.

It is not necessary, in fact, for the intensity of the light beam to be constant on the different objects which are to be illuminated.

The light is oriented, with respect to the support surface 110, at a predetermined angle relative to the vertical, equal to the angle of inclination of the shoulders 14, 16 of the rib 12 relative to the said vertical.

Owing to the arrangement of the light beam emitters (LEDs) 21 on the shoulders 20, 22 of the rib 12a, on the shoulder 26 of the rib 12b and on the shoulder 30 of the rib 12c, which are specially prepared, the light beams are oriented exactly so as to illuminate the required targets, minimizing the dispersion of light, the energy consumption and consequently minimizing the light pollution associated with the lighting system.

The apparatus sectioned longitudinally has the appearance of an upwardly concave broken polygonal line; in the case of FIG. 4a, the polygonal line is formed by 9 segments, a pair of segments identified respectively by the first shoulder 21 and second shoulder 22 of the rib 12, a third segment 110a, a second pair of segments identified respectively by the shoulders 24 and 26 of the rib 12b, a sixth segment 110b, a third pair of segments identified respectively by the shoulders 28 and 30 of the rib 12c and a ninth segment 110c.

The polygonal line of each individual rib is a triangle with the base perpendicular to the vertical or a right-angled triangle with a cathetus perpendicular to the vertical.

In this embodiment also, the orientation of the light beams emitted from the pair of shoulders may be symmetrical or asymmetrical, with respect to the vertical, depending on the working requirements.

All the embodiments of the invention described employ an electrical technology which allows rephasing of the line voltage, avoiding voltage peaks which may damage the light emitters.

The light beam generated by the LEDs has a high chromatic yield expressed by the chromatic yield reference index (RA).

Such an index defines the impact of different light sources on the perceived colour of objects and surfaces. The more illumination with sample colours does not change the chromatic appearance of the object or surface, the higher this value.

According to the invention, the chromatic yield index is very high (approximately 90) with regard to the class 2 laser light emission source (LEDs) filtered by the lenses 24.

The main feature of these light beams is the reduced heat dissipation compared to the conventional light sources; this objective is achieved by means of the use of LEDs as light emitters and lenses which function as a filter; as a result, the temperature within the support structure 8 of the lighting apparatus 6 is not more than 10 degrees higher the ambient temperature, differing markedly from the operating temperatures of 200-300 degrees of the prior art.

In view of this, the support structure 8 may contain a telecamera or any other accessories, electronic or otherwise, of a varying nature.

The telecamera incorporated in the lighting apparatus allows recording of an object, with the advantage, on the one hand of being scarcely visible or totally invisible, and on the other hand of being, in particular if incorporated in street lamps, fairly close to the illuminated object. The images, therefore, are very clear and of superior quality compared to those of the telecameras currently used.

The relatively low temperature also allows the use of less heavy materials for manufacture of the support structure 8 and the internal parts, reducing consequently both the weight and the dimensions of the apparatus as a whole.

The lighting apparatus according to the invention is applicable to any type of already existing lighting structure such as, for example, street lamps, external lamps, floodlights, spotlights and the like, by simply suitably choosing the dimensions of the flat surface and the rib.

In alternative embodiments, the flat surface is directed upwards and the emitted light is directed towards a reflective cover which is arranged above the shaped base and from where it is then reflected downwards in order to illuminate the chosen objects.

A further innovative feature consists in the possibility of inclining the shaped base at a certain angle, not more than 12 degrees, by means of suitable operating levers, so as to allow a general improved orientation of the light beams. Such an orientation is achieved always and in any case so that the light beams emitted have angles of orientation compatible with the existing regulations.

In the example according to FIGS. 5A and 5B there is no need to incline the body at 12° since the internal parts perform instead all the necessary functions and may be adjusted independently one arc at a time.

1. Lighting apparatus, in particular for a street lamp, which comprises a support structure (8), at least one light source (60) which is mechanically associated with said support structure (8), an electric power supply comprising power supply cables housed inside said support structure (8) and electrically connected to said light source (60), characterized in that said light source comprises a plurality of LED-type light emitters (21) able to generate single light beams (R) which are optically directed and characterized in that said support structure (8) comprises a shaped base (10) having, mounted thereon, said plurality of emitters (21) lying in respective planes of lie (P) defined by said shaped base and able to produce at least one overall beam of light with an orientation defined by the direction (R) of said individual beams and by the lie of said emitters.

2. Lighting apparatus according to claim 1, in which said shaped base (10) is formed by means of two or more curved profiles (50) which are arranged substantially alongside each other so as to form a series with a longitudinal direction of extension, being connected by means of hinges (52) to said support structure (8) at the ends (51), each said profile (50) being able to be oriented by means of rotation about the axis of rotation (Z) of the hinges (52).

3. Lighting apparatus according to claim 1, in which, with said apparatus (6) in the operative position (0), the direction of longitudinal extension (Y) of said series is substantially horizontal.

4. Lighting apparatus according to claim 1, in which, with said apparatus in the operative position (0), the concavity of said curved profiles (50) is directed downwards.

5. Lighting apparatus according to claim 1, in which said hinges (52) are aligned on a horizontal axis of rotation (Z) with said apparatus in the operative position (0).

6. Lighting apparatus according to claim 2, in which at least one curved profile (50) situated in the vicinity of a first end (53) of the series defines a beam oriented with a component towards the second end (54) of the series and at least one curved profile (50) situated in the vicinity of the second end (54) of the series defines a beam oriented with a component directed towards the first end (53) of the series, causing an intersection of said rays.

7. Lighting apparatus according to claim 1, in which said shaped base (10) is a single body.

8. Lighting apparatus according to claim 1, in which said shaped base (10) defines at least one concavity inside which said light sources (21) are arranged.

9. Lighting apparatus according to claim 1, in which said concavity is formed by means of flat surfaces (70) which are connected together at the periphery and each support an emitter (21).

10. Lighting apparatus according to claim 1, in which said concavity is obtained by the extension, in a longitudinal direction, of a downwardly concave line (30) with a polygonal shape, consisting of polygonal segments (32, 34, 36, 38, 40, 42).

11. Lighting apparatus according to claim 1, in which said emitters (21) are class A2 laser ray emitting LEDs.

12. Lighting apparatus according to claim 11, in which said class A2 laser emitting rays have an operating temperature 10 degrees less than the ambient temperature.

13. Lighting apparatus according to claim 11, in which said class A2 laser rays have a chromatic yield index not less than 90.

14. Lighting apparatus according to claim 1, in which, with said apparatus (6) in the operative position (0), said shaped base (10) defines inclined lies (P) able to orient the rays (R) of the emitters (21) at an angle of no more than 12 degrees with respect to a horizontal plane, thus keeping the emitted rays (R) within the horizon line.

15. Lighting apparatus according to claim 1, characterized in that it comprises a plurality of lenses (24) arranged above the emitters (21) so as to focus the light rays emitted.
